(19) United States
(12) Patent Application Publication
(10) Pub. No.: US 2002/0093531 A1
(43) Pub. Date: Jul. 18, 2002

(54) Adaptive display for video conferences

(76) Inventor: John Barile, Apex, NC (US)

Correspondence Address: David E Bennett, Coats & Bennett, 1400 Crescent Green, Suite 300, Cary, NC, 27511, US

(21) Appl. No.: 09/761,977

(22) Filed: Jan. 17, 2001

(51) Int. Cl. G06F 13/00

(52) U.S. Cl. 345/753; 345/764

(57) ABSTRACT

A communication terminal for video conferencing with remote participants, including a receiver receiving audio and video signals from a plurality of the remote participants, and a display. In one form, a comparator compares the audio signals and a controller controls the display to display the video images extracted from the video signals based on the comparison of the received audio signals. In another form, the display has a height greater than its width and operates in a portrait mode in a default condition, and a controller controls the display to display the extracted video images in a landscape mode when the receiver receives the video signals from a plurality of the remote participants. In yet another form, a processor associates the received audio signals with the video signal received from the same remote participant, with the display displaying one of the video images on the right and another video image on the left, where an audio output sends the audio signal associated with the one video signal to a right speaker and sends the audio signal associated with the other video signal to a left speaker.

### BACKGROUND OF THE INVENTION

The present invention is directed toward video conferencing, and more particularly toward with mobile terminals such as communicators.

Video conferencing among remote participants is well known, where images are sent by the participants as video signals for viewing on displays by the other participants.

Particularly if a participant of a video conference is using a handheld mobile terminal such as a cellular telephone or a communicator, the video image will be difficult to see on the necessarily small display provided with such mobile terminals. Many such terminals have a 1/4 VGA (320×240 pixels) or smaller display on which to present the images of video callers. It would be particularly difficult to see images on such displays if there are multiple video signals involved in the conference (e.g., video images of a plurality of remote participants of the conference) since the video images must be shrunk from an already small size in order to provide room on the display for multiple images. With a 1/4 VGA display, for example, simultaneous display of a two to four person conference would require each image to be 160×120 pixels or less. Smaller displays would result in still smaller images. This could result in video images so small and with such low resolution that the user of the mobile terminal may be unable to be reasonably assisted by the video displays of the conference.

The present invention is directed toward overcoming one or more of the problems set forth above.

### SUMMARY OF THE INVENTION

In one aspect of the present invention, a communication terminal for video conferencing with remote participants is provided, including a receiver receiving audio and video signals from a plurality of the remote participants, a comparator comparing the received audio signals from the remote participants, a display, and a controller controlling the display to display the video images of the participants based on the comparison of the received audio signals. In various forms of this aspect of the invention, the controller may control the display to variously highlight the video image extracted from the video signal associated with the corresponding audio signal selected by the comparator. The comparator may select an audio signal which is strongest to determine which of the participants is active.

In another aspect of the present invention, the communication terminal includes a receiver, a display having a height greater than its width and operating in a portrait mode in a default condition, and a controller controls the display to display the video images in a landscape mode when the wireless receiver receives the video signals from a plurality of the remote participants.

In yet another aspect of the present invention, the communication terminal includes a receiver, a processor identifying the received audio signals and associating each of the identified audio signals with the video signal received from the same remote participant, a display and an audio output. The display displays the video images from at least two of the remote participants with one of the video images being displayed on the right side of the display and another of the video images being displayed on the left side of the display. The audio output sends the audio signal associated with the one video signal to a right speaker and sends the audio signal associated with the other video signal to a left speaker.

Related methods of displaying video images extracted from video signals and outputting audio signals are also provided herein.

### BRIEF DESCRIPTION OF THE DRAWINGS

FIG. 1 is a block diagram of a mobile terminal with which the present invention may be used;

FIG. 2 is a mobile terminal according to one form of the present invention;

FIG. 3 is a mobile terminal according to another form of the present invention;

FIG. 4 is a mobile terminal according to other forms of the present invention;

FIG. 5 is a mobile terminal according to another form of the present invention;

FIG. 6 is a mobile terminal according to still another form of the present invention;

FIG. 7 is a block diagram of a communication system configuration in which the present invention may be used;

FIG. 8 illustrates multiplexed information in a video conference data stream according to one standard (H.323) with which the present invention may be used;

FIG. 9 is a block diagram of a video conference enabled system according to one standard (H.324) with which the present invention may be used; and

FIG. 10 is a block diagram of terminal equipment and processing according to one standard (H.323) with which the present invention may be used.

### DETAILED DESCRIPTION OF THE INVENTION

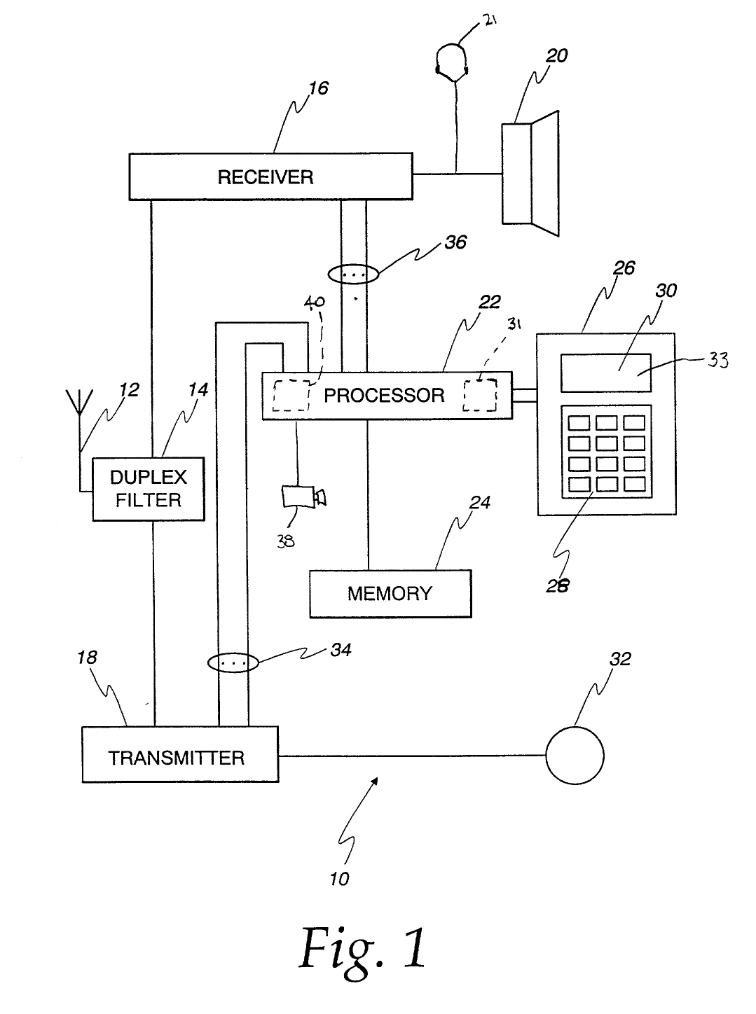

FIG. 1 is a block diagram of a mobile terminal 10 according to one form of the present invention. The mobile terminal 10 includes an antenna 12, a receiver 16, a transmitter 18, a speaker 20, a processor 22, a memory 24, a user interface 26 and a microphone 32. The antenna 12 is configured to send and receive radio signals between the mobile terminal 10 and a wireless network (not shown). The antenna 12 is connected to a duplex filter 14 which enables the receiver 16 and the transmitter 18 to receive and broadcast (respectively) on the same antenna 12. The receiver 16 and transmitter 18 together comprise a transceiver. The receiver 16 demodulates, demultiplexes and decodes the radio signals into one or more channels. Such channels include a control channel and a traffic channel for speech or data. The speech or data are delivered to the speaker 20 or other audio output such as headphones 21 (or other output device, such as a modem or fax connector). The speaker 20 and/or headphones 21 may be adapted to provide stereo sound (with left and right audio outputs). For video conferencing, there may also be a video channel for delivering video signals, including video data signals (e.g., which contain encoded visual representations of information such as a page of text).

The receiver 16 delivers information from the control and traffic channels to the processor 22. The processor 22 controls and coordinates the functioning of the mobile terminal 10 and is responsive to messages on the control channel and data on the traffic channels using programs and data stored in the memory 24, so that the mobile terminal 10 can operate within a wireless network (not shown). The processor 22 also controls the operation of the mobile terminal 10 and is responsive to input from the user interface 26. The user interface 26 includes a keypad 28 as a user-input device and a display 30 to give the user information. Typically, the display 30 has a greater height than width when the mobile terminal 10 is held upright, and can be used to display various information, including video images. A display controller 31 controls what is displayed on the display 30.

Other devices are frequently included in the user interface 26, such as lights, special purpose buttons and a touch-sensitive surface 33 on top of the display 30. The processor 22 controls the operations of the transmitter 18 and the receiver 16 over control lines 34 and 36, respectively, responsive to control messages and user input.

The microphone 32 (or other data input device) receives speech signal input and converts the input into analog electrical signals. The analog electrical signals are delivered to the transmitter 18. The transmitter 18 converts the analog electrical signals into digital data, encodes the data with error detection and correction information and multiplexes this data with control messages from the processor 22. The transmitter 18 modulates this combined data stream and broadcasts the resultant radio signals to the wireless network through the duplex filter 14 and the antenna 12.

A camera 38 may also be included with the mobile terminal 10 to capture video images and transmit such images via the transmitter 18. However, it should be understood that a camera 38 would not be required for the user of the mobile terminal 10 to advantageously participate in a video conference using the present invention (i.e., it would be within the scope of the invention for a participant to use a mobile terminal 10 which does not include his own image among the images, with the participant able nonetheless to view images of the other participants).

In accordance with one form of the invention, a comparator 40 is also included in the processor 22 as described further below.

It should be understood that while the present invention may be advantageously used with mobile terminals such as described above, including for example communicators and smartphones, it may also be used with other communication terminals which are used in video conferencing, including terminals which communicate via landlines rather than wireless signals.

In accordance with one aspect of the invention, the comparator 40 compares the audio signals received from the various participants in a video conference and from that comparison determines which of the participants is the active participant (i.e., which participant is then speaking and/or controlling the exchange of information at that time), and the controller 31 controls the display 30 to display the video images based on that comparison of the received audio signals, for example, by highlighting the video image associated with the participant who is in that manner determined to be the active participant.

For example, the comparator 40 can use the baseband, analog audio signal in the transmit and receive channels, and compare the outbound and inbound audio signals in a number of ways (e.g., simply comparing, or make an analog-to-digital conversion and then comparing). The signals may also be processed by the processor 22 prior to comparing by the comparator 40, for example, when there are multiple, simultaneous participants with some audio signal or high background noise. As another example, the active participant can be determined using the decoded digital audio channel information that is part of the H.324 specification/protocol. The H.324 set of protocols dictate, among other things, the data bandwidth, image sizes, voice sampling rates, logical data channels and control channels between the various participants in a video conference and their equipment. The information passed between the equipment involved in video conferences can identify the sources and destinations of the links, as well as the audio, video, data and control channels. More information regarding the H.324 set of protocols is set forth hereafter. However, it should be understood that the present invention could be used with still other protocol sets, including protocols unrelated to wireless communication where the invention is used with a terminal 10 which is not wireless as previously noted. In any event, with this example, all the inbound audio channels which are used to transfer sound by the participants during a video conference call can be monitored by the processor 22 while the decoding is in progress.

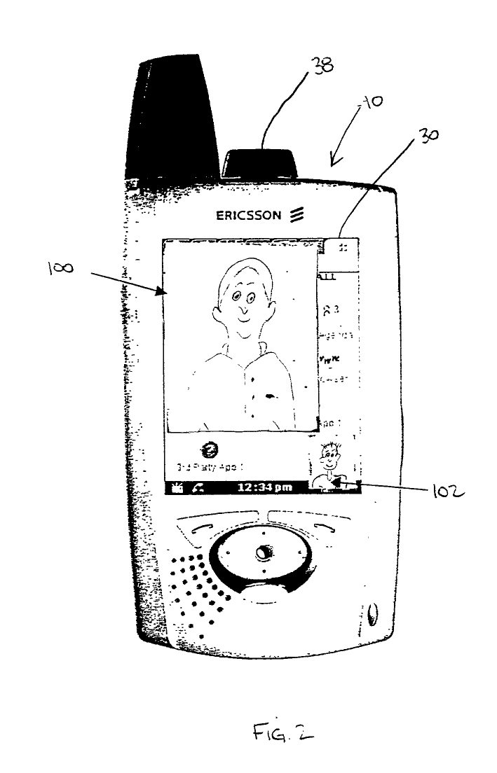

Reference will now be had to FIG. 2 which illustrates a mobile terminal 10 operating according to one form of the present invention. In this embodiment, the display 30 includes two windows 100, 102 of video signals received from participants in the conference call. At least one of the participants shown in the windows 100, 102 is a remote participant, and the other participant may be either a second remote participant or the local/host participant (the video signal from the local camera 38 may be shown on the display to assist the user of the mobile terminal 10 in ensuring that the user is holding the terminal 10 properly so that the video signal he is transmitting to the other participant is proper, with his image centered). In accordance with the present invention, the larger window 100 displays the video image associated with the active participant (i.e., the participant having the strongest audio signal and therefore presumably the participant who is actively communicating at that time in the conference). The smaller window(s) 102 display one or more of the other participant(s) who are not then actively participating (i.e., are not the current speaker as determined by a comparison of the audio signals by the comparator 40). Alternatively, only the active participant can be displayed on the display 30, thereby allowing the video image of the active participant to be displayed on the full screen at maximum size. The video image displayed on the larger window 100 is switched to a different video image when the active participant switches (with the video image associated with the new active participant displayed in the larger window 100).

In fact, in accordance with the present invention, the display of the video image associated with the active participant can take a variety of forms.

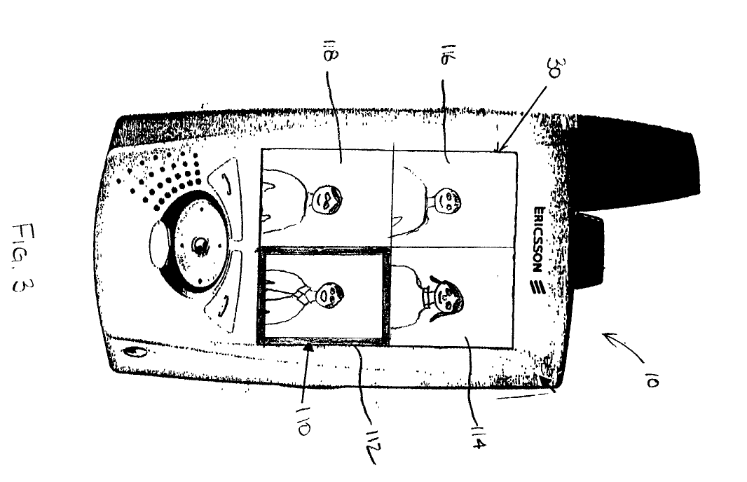

For example, as illustrated in FIG. 3, the window 110 displaying the active participant may be highlighted by surrounding it with a distinctive border 112. In that case, even if the window displaying the active participant is not larger than the window displaying the other participants (such as illustrated in FIG. 3), the border 112 will focus the user's attention on that window 110 and therefore make the smaller video image sufficiently clear to the user (e.g., the user will notice more details of the smaller window when he is able to ignore the other windows 114, 116, 118 associated with the other participants).

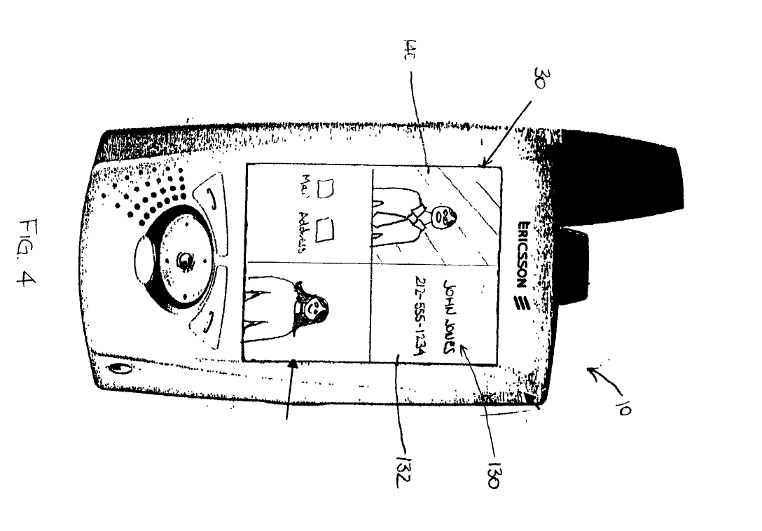

In another form, alphanumeric information 130 identifying the active participant (e.g., identifying caller ID information received when calls from the other participants are received) can be displayed, either superimposed on the window showing the video image of the active participant, or in a separate window 132 such as shown in FIG. 4. In that manner, the local user/host will be able to easily identify the remote speaker even if he may not recognize the speaker's voice, and further that identification would assist the local user/host in identifying the video image of the active participant (which the local user/host may recognize sufficiently even if the picture is small if the local user/host knows the persons participating in the conference).

In yet another form, the window displaying the active participant may be highlighted by using a different color scheme than used in the other windows (e.g., the active participant may be shown in color while the windows displaying the other participants are shown in black and white/monochrome). The angled background lines in the window 140 of the active participant in FIG. 4 schematically illustrate such a color difference between windows.

In yet another form the video images of the participants that are not the active participant, may be “frozen” on the screen until such time when each becomes the active participant. In this mode, only one window, that of the active participant, will produce moving video images. In addition to better identification of the active participant, this form reduces power consumption in the host device.

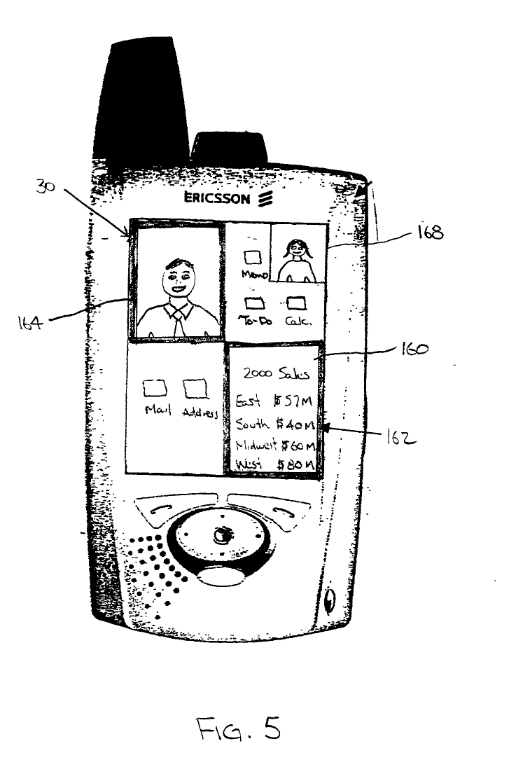

In another form, the signal from a remote participant may include video data signals (sent, e.g., over the data channel). Such video data signals may include images or graphics or textual materials (as opposed to a video image of the participants themselves), and such video data signals may be shown in a separate data window 160 such as shown in FIG. 5. In accordance with the present invention, that separate data window 160 may be highlighted in a suitable manner in conjunction with the video image of the active participant, such as by displaying both in equal sized windows (and other remote participants displayed in smaller windows 168) as illustrated in FIG. 5, and/or by highlighting both such windows in the same manner (such as the distinctive borders 162, 164 shown in FIG. 5). Alternatively, displaying the video image based on the active participant can be overridden when a video data signal is being sent, with the video data signal in that circumstance being automatically displayed in a preferred window (e.g., in a full screen window without any other images shown on the display 30).

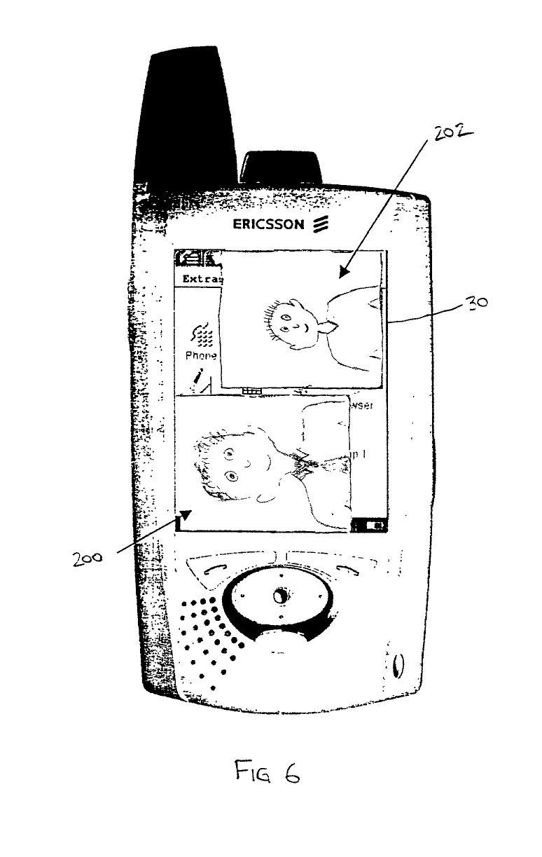

In an alternate form of the present invention shown in FIG. 6, in a video conferencing mode, the controller 31 may automatically shift the display 30 from a normal/default portrait mode to a landscape mode (with the images of the received video signals turned 90 degrees). For the typical display 30 which has a greater height than width (e.g., 320 pixels high and 240 pixels wide), this allows the windows 200, 202 (which are typically about the same proportions as the display—2×1.5) for two participants to be larger and therefore more easily seen with greater clarity. In the standard example given, rather than resulting in windows which are 160×120 pixels, the windows 200, 202 may be about 213×160 pixels. The user may then simply turn the mobile terminal 10 sideways and view the larger images. All the previously described image viewing and control method apply to this rotated orientation as well.

In still another alternate form of the present invention, the audio output to the speaker 20 and/or headphones 21 may be in two tracks (left and right), where the comparator 40 determines the active participant, and then the sound is output to either the left or right track corresponding to the location on the display 30 of the window showing the video image of the active participant. For example, if the image of the active participant is being displayed in a window on the left side of the display 30, then the audio may be output to the left side (e.g., the left speaker of the headphones 21).

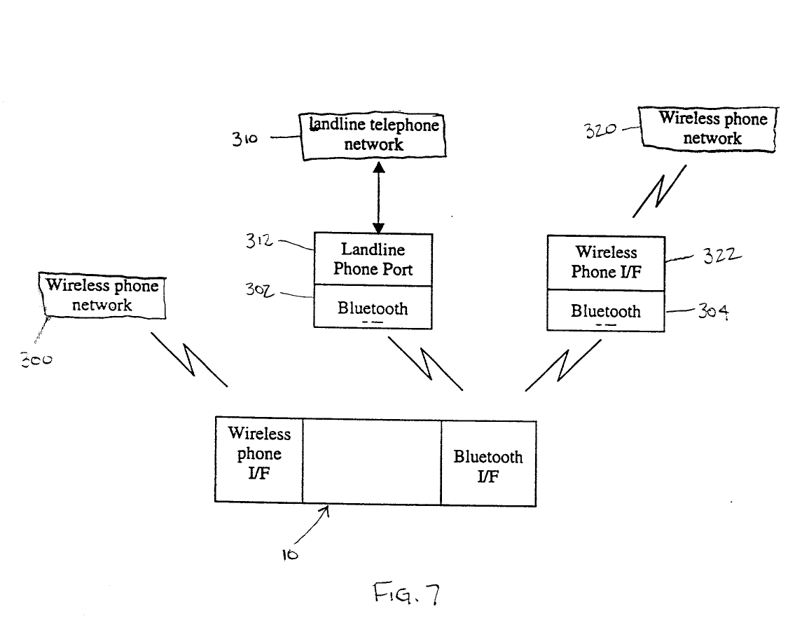

Reference will now be had to FIGS. 7-10 which disclose in detail one example of communication in a system in which the present invention may be used.

FIG. 7 illustrates a mobile terminal 10 which may be connected to a wireless telephone network 300 (such as a cellular telephone system) for circuit switched voice and data connections. The mobile terminal 10 illustrated in FIG. 7 can also make voice and data connections using Bluetooth wireless networks 302, 304, through which connections may be made to a landline telephone network 310, via a landline phone port 312, and/or a wireless telephone network 320 (which may be the same or different than network 300), via wireless phone I/F 322. Using such communication connections would allow for two or more voice/data connections to be active simultaneously. Using these connections, the mobile terminal 10 in FIG. 7 can establish itself as a video conference call hub or server.

Consistent with previous discussion, such video conference calls can use the H.324M standard recommended from the International Telecommunications Union. This standard dictates the data rate, control scheme, and digital voice and image formats, among other important parts of the video conference connection. With such standard, it will be recognized that the audio signal may not be a separate signal per se, but rather could be a digital signal encoded into the various bits of data transmitted by the wireless signal. Determination of the active participant using the associated audio data is very applicable within these ITU standards.

However, it should be recognized that there are still other multimedia teleconference standards could be used with the present invention. For example, ITU-T T.120 standards address real time data conferencing (audiographics), H.320 standards address ISDN videoconferencing, H.323 standards address video (audiovisual) communication on local area networks, H.324 standards address high quality video and audio compression over plain-old-telephone-service (POTS) modem connections, and H.324M standards address high quality video and audio compression over low-bit-rate, wireless connections. H.324M standards rely heavily on the H.323 recommendation which presents the general protocols for multimedia teleconferencing over various networks (e.g., switched circuit, wireless, Internet, ISDN) and the requirements for the different types of equipment used in such applications. Therefore, under such standards, a connection through a Bluetooth network 302 to a landline telephone network 310 will not use the discrete PCM digital audio path, normally reserved for local Bluetooth connections, for the voice portion of the call but instead the audio will be part of the data stream transmitted across the Bluetooth interface (port 302 or 304).

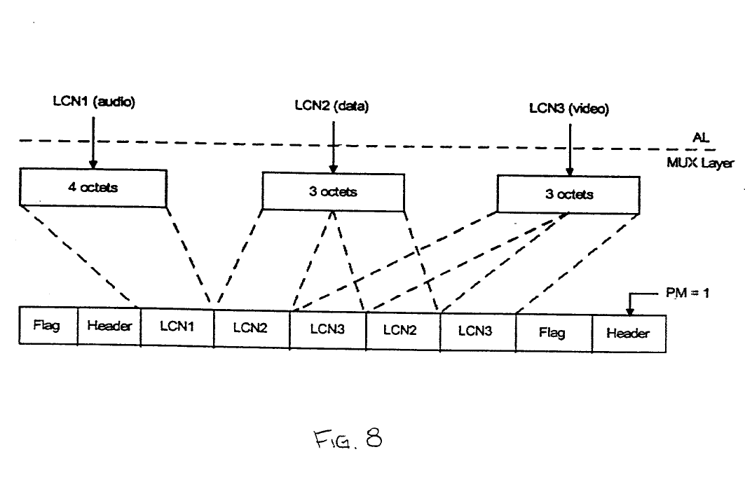

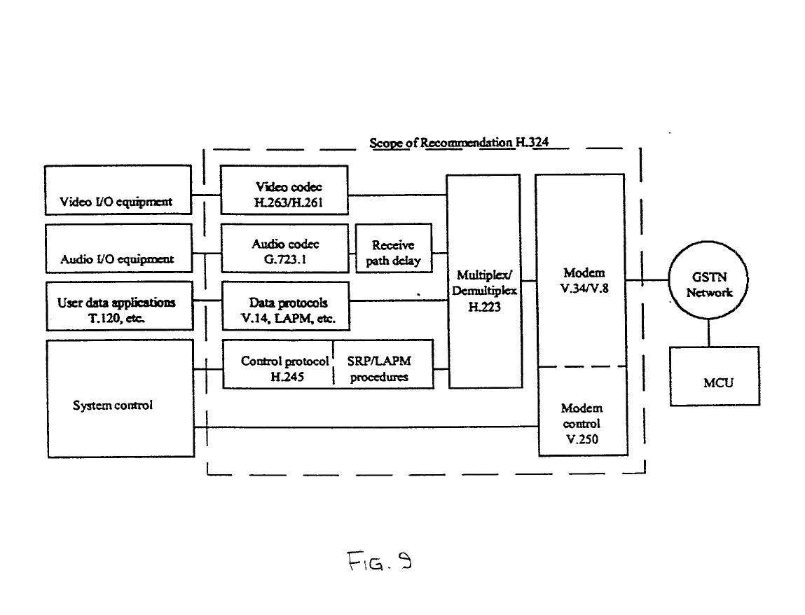

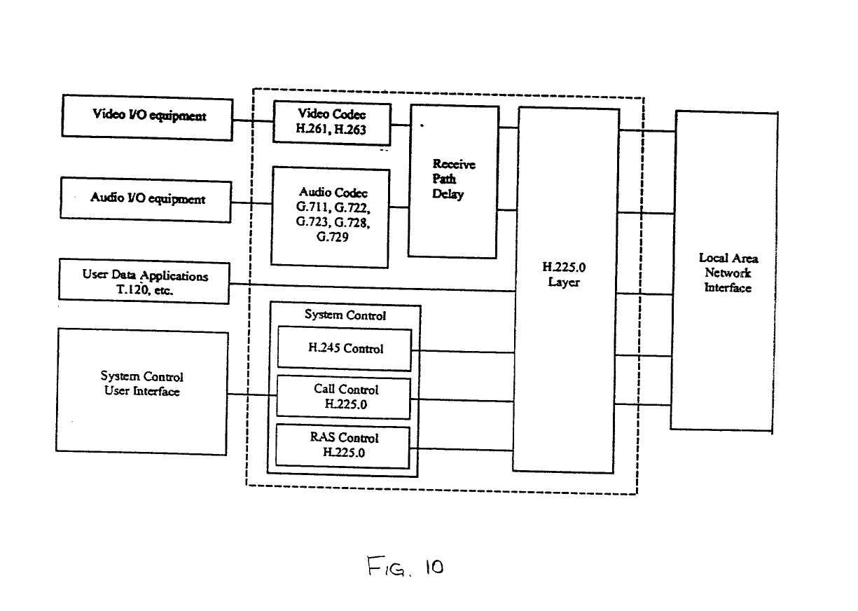

FIG. 8 shows the breakdown of the voice, data and image information contained in the H.323 video conference data stream, FIG. 9 is a basic block diagram of a video conference enabled system using the H.324 standard, and FIG. 10 is a block diagram of terminal equipment and processing in accord with the H.323 standard. The above identified standards of the International Telecommunications Union, which are hereby fully incorporated by reference, are well known by those skilled in the art, and are therefore not discussed in further detail herein. Also, as already noted, such standards are merely examples of the types of communication with which the present invention can be used, and still other video conference standards (including standards which may not yet even be established) could be used with the present invention by those having an understanding of the invention from the disclosure herein.

In any event, in the example using the above standards, the video conference data stream from each remote participant is received on a separate channel, or on separable portions of a single channel, and therefore the audio signal multiplexed in each channel can be extracted individually from the stream and processed by the processor 22. Such processing (which may occur between the Audio Codec and Audio I/O Equipment boxes in FIGS. 9 and 10) may include conversion/decompression of the encoded digital data into standard, periodic audio samples (pulse code modulation or PCM). The processor 22 and comparator 40 can then detect the magnitude of the audio signals received and compare them to determine the active participant.

Further, frequency analysis could be performed on the audio samples, although such a process would be more processing-intensive than the above described processing. A Fast-Fourier Transform (FFT) or similar time-to-frequency conversion in the standard, high-energy portion of the speaker's voice band can be performed to determine that the speaker is indeed speaking and the audio signal coming from the remote participant is not ambient or network noise.

As another alternative, the audio samples may be converted to analog, where the signal is filtered and the voice-band energy is detected. The processor 22 and comparator 40 determine which remote speaker is speaking based on the knowledge of the data stream from which it extracted the audio samples.

It should be understood, however, that the above methods of analyzing audio signals to determine the active participant are merely examples, and that any method by which it may be determined which of the participants in the video conference is actively speaking at the time may be used with the aspect of the present invention comparing such audio signals. In that regard, it should be recognized that the comparison of audio signals may be done using samples over a selected short time span to prevent the active video image window from being switched too quickly and undesirably oscillate between participants. Still further, time delay may be provided in changing to a new active participant to prevent undesirable quick switching back and forth.

In fact, a wide variety of forms may be used in accordance with the present invention where the active participant is in any manner displayed on the display 30 or a stereo sound is used in a different manner based on a comparison of the audio signals of the various conference participants. Further, it should be understood that any of the above display options may be disabled when desired (e.g., to focus on one participant or to view graphic information only), or used in conjunction with each other (e.g., displaying the active participant alphanumeric information and displaying the image of that active participant in a larger window 100). Further, the user may be provided the additional option of “locking” a video image being displayed on the screen (rather than continually updating the image to reflect new images) to capture or record a video data or participant image. Still further, the display options according to the invention may all be disabled (e.g., if desired a selected participant may be displayed in the display 30 independent of the relative strength of the received audio signals). The keypad 28 or touch-sensitive screen, for example, may include a real or virtual key or keys for choosing such options.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A communication terminal for video conferencing with remote participants, comprising:
a receiver receiving audio and video signals from a plurality of said remote participants;
a comparator comparing said received audio signals from said remote participants;
a display; and
a controller controlling said display to display a video image extracted from said video signals based on the comparison of said received audio signals.

2. The communication terminal of claim 1, wherein said comparator selects an active participant from said remote participants.

3. The communication terminal of claim 2, wherein said comparator selects as said active participant said remote participant from which the strongest audio signal is received.

4. The communication terminal of claim 1, wherein said comparator compares said audio signals over a selected period of time.

5. The communication terminal of claim 1, wherein said controller controls said display to freeze all but one extracted video image of one remote participant based on said comparison of said received audio signals from said remote participants by said comparator.

6. The communication terminal of claim 1, wherein said controller controls said display to highlight one extracted video image of one remote participant based on said comparison of said received audio signals from said remote participants by said comparator.

7. The communication terminal of claim 6, wherein said controller controls said display to highlight said one video image by displaying said one video image in an area larger than the area in which each other video image is displayed.

8. The communication terminal of claim 7, wherein said controller controls said display to display only said one video image.

9. The communication terminal of claim 7, wherein said controller controls said display to display video images other than said one video image in areas smaller than the area in which said one video image is displayed.

10. The communication terminal of claim 6, wherein said controller controls said display to highlight said one video image by displaying a distinctive border around said one video image.

11. The communication terminal of claim 6, wherein said controller controls said display to highlight said one video signal by displaying alphanumeric identification regarding said one remote participant.

12. The communication terminal of claim 6, wherein said controller controls said display to highlight said one video image by displaying video images other than said one video image using a color scheme different than the color scheme used to display said one video image.

13. The communication terminal of claim 1, wherein:
said receiver receives a video data signal; and
said controller controls said display to highlight one video image and a video data image extracted from said video data signal based on said comparison of said received audio signals from said remote participants by said comparator.

14. The communication terminal of claim 13, wherein said controller controls said display to highlight said video data image and said video image associated with the strongest received audio signal.

15. A mobile terminal for video conferencing with remote participants, comprising:
a wireless receiver receiving audio and video signals from a plurality of said remote participants;
a comparator comparing said received audio signals from said remote participants;
a display; and
a controller controlling said display to display video images extracted from said video signals based on the comparison of said received audio signals.

16. The mobile terminal of claim 15, wherein said comparator selects an active participant from said remote participants.

17. The mobile terminal of claim 16, wherein said comparator selects as said active participant said remote participant from which the strongest audio signal is received.

18. The mobile terminal of claim 15, wherein said comparator compares said audio signals over a selected period of time.

19. The mobile terminal of claim 15, wherein said controller controls said display to freeze all but one extracted video image of one remote participant based on said comparison of said received audio signals from said remote participants by said comparator.

20. The mobile terminal of claim 15, wherein said controller controls said display to highlight one video image of one remote participant based on said comparison of said received audio signals from said remote participants by said comparator.

21. The mobile terminal of claim 20, wherein said controller controls said display to highlight said one video image by displaying said one video image in an area larger than the area in which each other video image is displayed.

22. The mobile terminal of claim 21, wherein said controller controls said display to display only said one video image.

23. The mobile terminal of claim 21, wherein said controller controls said display to display video images other than said one video image in areas smaller than the area in which said one video image is displayed.

24. The mobile terminal of claim 20, wherein said controller controls said display to highlight said one video image by displaying a distinctive border around said one video image.

25. The mobile terminal of claim 20, wherein said controller controls said display to highlight said one video signal by displaying alphanumeric identification regarding said one remote participant.

26. The mobile terminal of claim 20, wherein said controller controls said display to highlight said one video image by displaying video images other than said one video image using a color scheme different than the color scheme used to display said one video image.

27. The mobile terminal of claim 15, wherein:
said receiver receives a video data signal; and
said controller controls said display to highlight one video image and a video data image extracted from said video data signal based on said comparison of said received audio signals from said remote participants by said comparator.

28. The mobile terminal of claim 27, wherein said controller controls said display to highlight said video data image and said video image associated with the strongest received audio signal.

29. A mobile terminal for video conferencing with remote participants, comprising:
a wireless receiver receiving audio and video signals from a plurality of said remote participants;
a display having a height greater than its width, said display operating in a portrait mode in a default condition; and
a controller controlling said display to display video images extracted from said video signals in a landscape mode when said wireless receiver receives said video signals from a plurality of said remote participants.

30. A communication terminal for video conferencing with remote participants, comprising:
a receiver receiving audio and video signals from a plurality of said remote participants;
a processor identifying said received audio signals and associating each of said identified audio signals with said video signal received from the same remote participant;
a video display;
a controller controlling said display to display video images extracted from said video signals from at least two of said remote participants, one of said video images being displayed on the right side of said display and another of said video images being displayed on the left side of said display; and
an audio output sending said audio signal associated with said one video signal to a right speaker and sending said audio signal associated with said other video signal to a left speaker.

31. A method of displaying video images on a display of a mobile terminal video conferencing with at least two other participants, comprising:
receiving at the mobile terminal a video signal containing a video image and an audio signal from each participant;
comparing the audio signals received from said participants;
displaying the video images on the mobile terminal display based on the comparison of the audio signals.

32. The method of claim 31, wherein comparing the audio signals received from said participants determines an active participant.

33. The method of claim 32, wherein said active participant is said participant from whom the strongest audio signal is received.

34. The method of claim 31, wherein said comparing the audio signals received from said participants compares said audio signals over a selected period of time.

35. The method of claim 31, wherein said displaying the video image on the mobile terminal display based on the comparison of the audio signals comprises highlighting one video image.

36. The method of claim 35, wherein said highlighting one video image comprises displaying said one video image in an area larger than the area in which each other video image is displayed.

37. The method of claim 36, wherein only said one video image is displayed.

38. The method of claim 36, wherein said other video images are displayed in areas smaller than the area in which the one video image is displayed.

39. The method of claim 35, wherein said highlighting one video image comprises displaying a distinctive border around said one video image.

40. The method of claim 35, wherein said highlighting one video image comprises displaying alphanumeric identification regarding said one video signal.

41. The method of claim 35, wherein said highlighting one video image comprises freezing all but said one video image on said display.

42. The method of claim 35, wherein said highlighting one video image comprises displaying video images other than said one video image using colors different than colors used to display said one video image.

43. The method of claim 31, further comprising:
receiving a video data signal at said receiver; and
wherein said displaying the video signal on the mobile terminal display based on the comparison of the audio signals comprises highlighting one video image and a video data image extracted from said video data signal.

44. The method of claim 43, wherein said highlighting one video image and said video data image comprises highlighting said video image associated with the strongest received audio signal.

45. A method of displaying video images on a display of a mobile terminal, comprising:
displaying information on the mobile terminal display in a portrait mode;
receiving a video signal containing a video image at the mobile terminal from a remote participant;
displaying video images on the mobile terminal display in a landscape mode when more than one video image is displayed.

46. A method of outputting audio and video signals on a mobile terminal video conferencing with at least two other participants, comprising:
receiving at the mobile terminal an audio signal and a video signal containing a video image from each participant;
processing said audio signal from each participant to associate each of said received audio signals with said video signal received from the same remote participant;
displaying the video images on a mobile terminal display with one video image displayed on the right side of said display and another video image displayed on the left side of said display;
outputting said audio signal associated with said one video signal to a right speaker; and
outputting said audio signal associated with said other video signal to a left speaker.
